(19) United States
(12) Patent Application Publication
(10) Pub. No.: US 2002/0045434 A1
(43) Pub. Date: Apr. 18, 2002

(54) System and method for transmitting information modulated radio frequency signals using infrared transmission

(76) Inventors: Lee Masoian, West New York, NJ (US); Vahram Gurjian, Long Island City, NY (US)

Correspondence Address: QUARLES & BRADY LLP, RENAISSANCE ONE, TWO NORTH CENTRAL AVENUE, PHOENIX, AZ, 85004-2391, US

(21) Appl. No.: 09/943,962

(22) Filed: Aug. 31, 2001

Related U.S. Application Data
(60) Provisional application No. 60/229,620, filed on Aug. 31, 2000.

(51) Int. Cl. H04Q 7/20

(52) U.S. Cl. 455/403; 455/524

(57) ABSTRACT

A method and system for transmitting information modulated radio frequency (RF) signals between a plurality of communication nodes includes a plurality of transceivers. One or more first transceivers receive a first modulated RF signal and convert it to a modulated infrared (IR) signal, and a second modulated IR signal and convert it to a second modulated RF signal. One or more second transceivers receive the first modulated IR signal from the first transceiver and convert it to a third modulated RF signal, and receive a fourth modulated RF signal and convert it to the second modulated IR signal. The third modulated RF signalis substantially equivalent to the first modulated RF signal, and the second modulated RF signal is substantially equivalent to the fourth modulated RF signal.

This application claims the benefit of U.S. Provisional Application No. 60/229,620, filed Aug. 31, 2000.

### BACKGROUND OF THE INVENTION

1. Field of the Invention

The present invention relates to radio frequency (RF) signal transmission and, more particularly, to a system and method for transmitting RF signals via an infrared (IR) link.

2. Description of Related Art

The field of communications continues to expand, especially in the field of wireless communications. Much of this expansion is being driven by consumer (both commercial and non-commercial) desire for wireless communication capabilities. As a result, the need to provide secure, broadband, high-speed wireless communication systems is becoming a requirement for wireless system designers.

Wireless systems, such as cellular telephone systems, transmit information using radio frequency (RF) signals. More specifically, as is generally known, information such as voice or data from one communication node modulates an RF signal carrier, which facilitates the transfer of the information to another communication node. At the other communication node, the information is demodulated from the RF signal carrier. Numerous other wireless devices, including garage door openers, cordless telephones, etc. also use RF signals to transmit information. Thus, as more and more wireless devices are developed, the RF spectrum is becoming more and more crowded, creating potential (and actual) RF interference problems.

One solution to the RF interference problem is to use non-RF signals for information carriers. For example, the infrared (IR) spectrum may also be used as a carrier. Presently, however, IR technology utilizes RF over fiber, meaning that the RF is converted to IR but is transmitted over fiber optic cable. While RF over fiber may present a potential solution to RF interference, it also presents its own problems. For example, the capital costs involved in purchasing, designing, and installing the cable, which may include the cost associated with construction and/or modification of new and/or existing structures, may be significant.

Hence, there is a need in the art for a system and method for transmitting information modulated RF signals between communication nodes that solves the drawbacks of existing technology that are noted above. Namely, a system and method that provides secure, high-speed, broadband wireless information transmission without incurring significant capital costs for installation, while simultaneously preventing further congestion of the RF spectrum.

### SUMMARY OF THE INVENTION

The present invention provides a system and method for securely transmitting high-speed, broadband information modulated RF signals between communication nodes without further impact on the RF spectrum, and without incurring significant capital costs.

In one aspect of the present invention, a system for transmitting information modulated radio frequency (RF) signals between a plurality of communication nodes includes a first transceiver and a second transceiver. The first transceiver is operable to receive a first modulated RF signal and convert the first modulated RF signal to a first modulated infrared (IR) signal. The second transceiver is operable to receive the first modulated IR signal from the first transceiver and convert the first modulated IR signal to a second modulated RF signal that is substantially equivalent to the first modulated RF signal.

In another aspect of the present invention, a method of transmitting information modulated radio frequency (RF) signals between a plurality of communication nodes includes converting, at a first node, a first modulated RF signal to a first modulated infrared (IR) signal. The first modulated IR signal is transmitted from the first node to a second node. The first modulated IR signal is received at the second node, and is converted to a second modulated RF signal that is substantially equivalent to the first modulated RF signal.

Other independent features and advantages of the preferred sensor will become apparent from the following detailed description, taken in conjunction with the accompanying drawings which illustrate, by way of example, the principles of the invention.

### BRIEF DESCRIPTION OF THE DRAWINGS

FIG. 1 is a block diagram of a system for transmitting modulated radio frequency signals between a plurality of communication nodes;

FIG. 2 is a functional block diagram of a transmission node and a receiver node that comprise a two node communication system similar to that depicted in FIG. 1;

FIG. 3 is a block diagram of a system for transmitting modulated radio frequency signals between a plurality of communication nodes using the system depicted in FIG. 2; and

FIG. 4 is an alternative embodiment of a system for transmitting modulated radio frequency signals between a plurality of communication nodes.

### DETAILED DESCRIPTION OF PREFERRED EMBODIMENTS

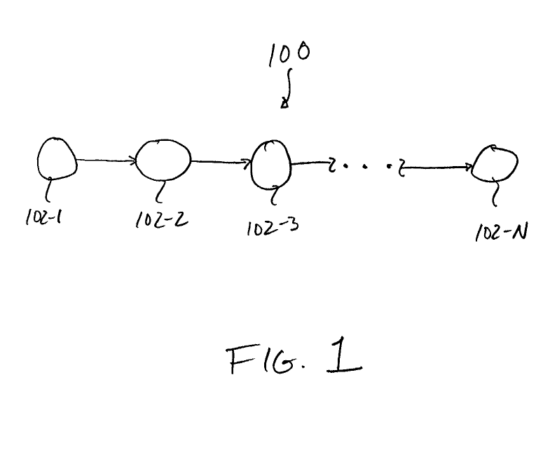

A communication system for transmitting information modulated radio frequency (RF) signals between a plurality of communication nodes according to an embodiment of the present invention is depicted in FIG. 1. The communication system 100 includes a plurality of communication nodes 102-1, 102-2, 102-3, . . . 102-N communicating with one another in a series-type configuration. In other words, a first communication node 102-1 transmits information to a second communication node 102-2, which in turn transmits the information to a third communication node 102-3, and so on through to an Nth communication node 102-N. Thus, each of the communication nodes 102-1, 102-2, 102-3, . . . 102-N may be generally referred to as a communication link.

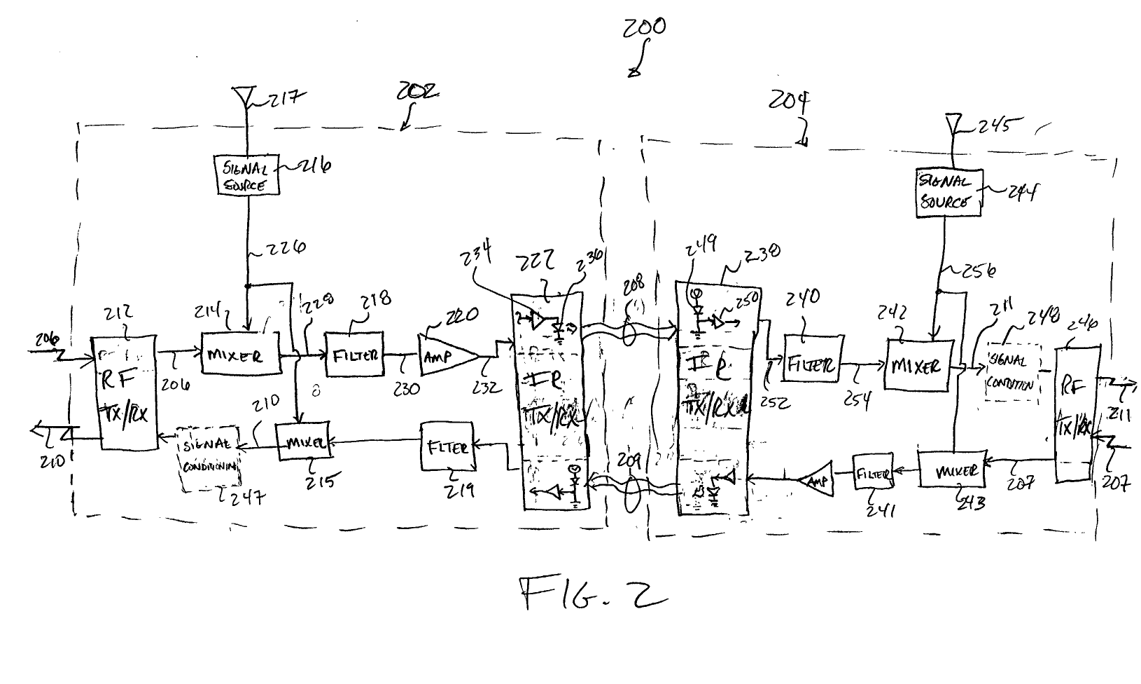

The communication nodes 102-1, 102-2, 102-3, . . . 102-N depicted in FIG. 1 transmit the information to a successive node via modulated infrared signals. Thus, the information is not only transmitted in a wireless fashion, but it is also transmitted without the threat of RF interference. The manner in which this is accomplished will now be discussed in more detail. In doing so, reference should now be made to FIG. 2, which depicts a functional block diagram of a transmission node and a receiver node that comprise a two-node communication system 200.

The two-node communication system 200 depicted in FIG. 2 includes a first transceiver 202 and a second transceiver 204. The first 202 and second 204 transceivers are configured to receive a first 206 and a second 207 modulated RF signal, respectively. The first transceiver 202, as will be discussed in more detail below, converts the first modulated RF signal 206 to a first modulated IR signal 208, and receives a second modulated IR signal 209 from the second transceiver 204 and converts it to a third modulated RF signal 210 that is substantially equivalent to the second modulated RF signal 207. Similarly, the second transceiver 204 receives and converts the first modulated IR signal 208 from the first transceiver 202 and converts it to a fourth modulated RF signal 211 that is substantially equivalent to the first modulated RF signal 206. The third 210 and fourth 211 modulated RF signals are then transmitted to their respective intended destinations, such as, for example, another cellular telephone device. The information that modulated the first 206 and second 207 modulated RF signals can then be demodulated from the third 210 and fourth 211 modulated RF signals, respectively.

For convenience, the circuitry in the first transceiver 202 that is used to convert the first modulated RF signal 206 to the first modulated IR signal 208 will first be described in detail, followed by a detailed description of the circuitry in the second transceiver 204 that is used to convert the first modulated IR signal 208 to the fourth modulated RF signal 211. The reason for this, as will become apparent, is that the first 202 and second 204 transceivers each include substantially identical circuitry for converting RF to IR, and vice-versa.

Turning first to the first transceiver 202, it can be seen that the first transceiver 202 preferably includes a first RF transceiver 212, a first mixer 214, a second mixer 215, a first signal source 216, a first filter circuit 218, a second filter circuit 219, a first amplifier circuit 220, and an IR transceiver 222. The first transceiver 202 may also include first signal conditioning circuitry 247, which is shown in phantom.

The first RF transceiver 212 receives various types of modulated RF signals 206 from one or more modulated RF signal sources (non-illustrated). These signal sources include, but are not limited to, cellular signal sources, personal communication system (PCS) signal sources, ultra-high frequency (UHF) signal sources, and very-high frequency (VHF) signal sources. The first RF transceiver 212 may be any one of numerous RF receivers known in the art that are capable of receiving one or all of these types of modulated RF signals. Moreover, although depicted and described as a single transceiver unit, it will be appreciated that the first RF transceiver 212 may be implemented as physically separate RF receiver and transmitter components.

The first RF transceiver 212 supplies the received modulated RF signals 206 to the first mixer 214. The first reference signal source 216 also supplies a first reference signal 226 to the first mixer 214. The first mixer 214 then combines these two signals and supplies a fifth modulated RF signal 228. The first mixer circuit 214 may be any one of numerous mixer circuits known in the art. However, it is noted that the first mixer 214 is preferably configured such that the fifth modulated RF signal 228 has a principle frequency that is lower than the first modulated RF signal 224. This is because modulation of an IR signal is generally not supported at least by the frequencies associated with modulated cellular and PCS signals.

It is additionally noted that the first reference signal source 216 preferably comprises a receiver that is tuned to receive signals from a Global Positioning Satellite (GPS), and thus includes an appropriately tuned first antenna 217. Thus, in the preferred embodiment, the first reference signal 226 supplied by the GPS receiver 216 is a timing signal. As will be described further below, the second transceiver 204 preferably includes a substantially identical GPS receiver that similarly provides a timing signal. These GPS timing signals are provided so that phase coherency is maintained when either or both of the first 206 and second 207 modulated RF signals received by the first 202 and second 204 transceivers, respectively, are (or include) modulated cellular or PCS signals. It will be appreciated that the first reference signal source 216 is not limited to a GPS receiver if phase coherency is not an issue with the received modulated RF signals 206, 207.

Returning once again to FIG. 2, the fifth modulated RF signal 228 output from the first mixer circuit 214 is supplied to the first filter circuit 218. The first filter circuit 218 is preferably a low-pass filter that removes unwanted high frequencies, including noise, from the fifth modulated RF signal 228 that are an inherent by-product of the signal mixing process. The filtered fifth modulated RF signal 230 output from the first filter circuit 228 is preferably amplified by the amplifier circuit 220, and this amplified and filtered fifth modulated RF signal 232 is then supplied to the first IR transceiver 222.

The first IR transceiver 222 receives the amplified and filtered fifth modulated RF signal 232 from the amplifier circuit 220. The IR transmitter portion of the first IR transceiver 222 may be any one of numerous IR transmitters known in the art, which generally includes a driver circuit 234 and a variable intensity IR source 236. In a particular preferred embodiment, the variable intensity IR source 236 comprises one or more laser diodes. Specifically, the transmitter portion of the first IR transceiver 222 receives the amplified and filtered fifth modulated RF signal 232 from the amplifier circuit 220 and modulates the intensity of the IR source 236 to generate the first modulated IR signal 208. The first modulated IR signal 208 is then wirelessly transmitted through the atmosphere to the second transceiver 204. A more detailed discussion of the receiver portion of the first IR transceiver 222 will be provided below when the second transceiver 204 is discussed. As with the first RF transceiver 212, although it is depicted and described as a single transceiver unit, it will be appreciated that the first IR transceiver 222 may be implemented as physically separate IR receiver and transmitter components. In addition, a description of the remaining portions of the first transceiver 202 identified above will be deferred, since it is substantially identical to those portions of the second transceiver 204 that are described in detail below.

Since the signals being transmitted from the first transceiver 202 to the second transceiver 204, and vice-versa, are IR signals, the first 202 and second 204 transceivers are configured for line-of-sight communication with one another. The distance between the first 202 and second 204 transceivers may vary from a few feet up to several miles. In a preferred embodiment however, the first 202 and second 204 transceivers are within about 3 miles of one another.

Turning now to a description of the second transceiver 204, it is seen that the second transceiver 204 is substantially identical to the first transceiver 202 and preferably includes a second IR transceiver 238, a third filter circuit 240, a fourth filter circuit 241, a third mixer 242, a fourth mixer circuit 243, a second reference signal source 244, and a second RF transceiver 246. The second transceiver 204 may also include second signal conditioning circuitry 248, which is shown in phantom.

The second IR transceiver 238 may be any one of numerous IR transceiver devices known in the art, but is preferably identical to the first IR transceiver 222. Thus, it may be implemented as an integral device or as physically separate IR receiver and transmitter components. In either case, the receiver portion of the second IR transceiver 238 (and the first IR transceiver 222) generally includes an IR sensitive device 249, such as one or more properly biased photodiodes, and one or more amplifier circuits 250. With this particular configuration, the receiver portion of the second IR transceiver 238 receives the first modulated IR signal 208 from the first transceiver 202 and modulates the voltage across the IR sensitive device 249, which is then amplified by the one or more amplifier circuits 250 to generate a sixth modulated RF signal 252.

The sixth modulated RF signal 252 output from the second IR transceiver 238 is supplied to the third filter circuit 240. Similar to the first filter circuit 218, the third filter circuit 240 is a low-pass filter that removes unwanted high frequency components, including noise, from the sixth modulated RF signal 252.

The filtered sixth modulated RF signal 254 output from the third filter circuit 240 is then supplied to the third mixer circuit 242. Similar to the first mixer circuit 214, the third mixer circuit 242 receives a second reference signal 256 from the second reference signal source 244. The third mixer circuit 244, also similar to the first mixer 214, combines these two signals and supplies the fourth modulated RF signal 211 as an output. The third mixer circuit 240 may be any one of numerous mixer circuits known in the art that is configured to demodulate the fourth modulated RF signal 211 from the filtered sixth modulated RF signal 254. The fourth modulated RF signal 211, as was noted above, is substantially equivalent to the first modulated RF signal 206 received by the first transceiver 202 and, thus, is modulated with the same information.

It is further noted that, as with the first reference signal source 216, the second reference signal source 244 preferably comprises a receiver that is tuned to receive GPS signals, when the RF signals 206, 207 received by the first 202 and second 204 transceivers, respectively, are (or include) modulated cellular or PCS signals. Thus, a properly tuned second antenna 245 is additionally coupled to the second reference signal source 244. It will be appreciated that the second reference signal source 244 is not limited to a GPS receiver if phase coherency is not an issue with the received modulated RF signals 206, 207.

The fourth modulated RF signal 211 output from the second mixer 242 may be further processed by the signal conditioning circuitry 248. In either case, the fourth modulated RF signal 211 is then transmitted by the second RF transceiver 246 to its intended end-use destination.

As was noted above, the first 202 and second 204 transceivers include substantially identical circuitry for receiving and converting modulated RF signals to modulated IR signals and then transmitting the modulated IR signals, and vice-versa. In the depicted embodiment, the circuitry in the first transceiver 202 that converts the second modulated IR signal 209 received from the second transceiver 204 to the third modulated RF signal 210 is identical to that used in the second transceiver 204 for converting the first modulated IR signal 208 to the fourth modulated RF signal 211. Similarly, the circuitry in the second transceiver 204 that converts the second modulated RF signal 207 to the second modulated IR signal 209 is identical to that used in the first transceiver 202 for converting the first modulated RF signal 206 to the first modulated IR signal 208. Hence, further description of each of this circuitry will not be provided.

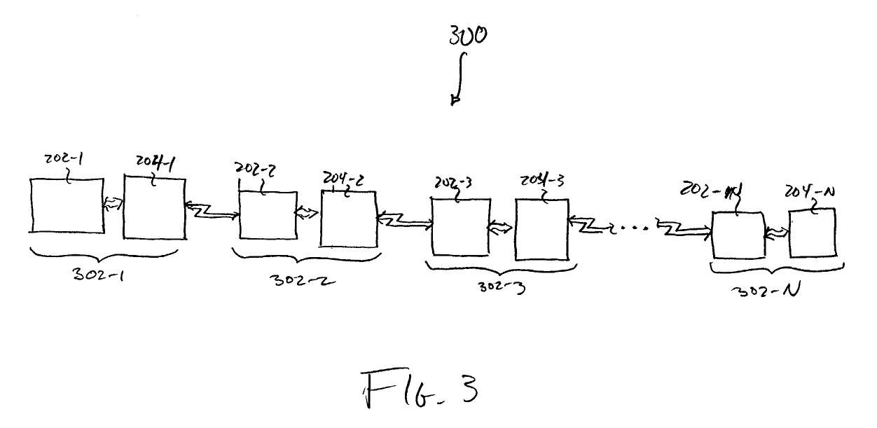

It will be appreciated that the system 200 described above and depicted in FIG. 2 is only exemplary of one embodiment. Indeed, it will be appreciated that the system of FIG. 2 is readily extendable to the system 100 depicted in FIG. 1, where the distance that the system 200 needs to cover exceeds the capability of two transceivers. This system extension can be accomplished using various methods. One method for accomplishing it is depicted in FIG. 3, in which the system 200 of FIG. 2 is repeated N-number of times. That is, the system 300 depicted in FIG. 3 includes a first transceiver pair 302, including a first transceiver 202-1 and a second transceiver 204-1, a second transceiver pair 304, including a first transceiver 202-2 and a second transceiver 204-2, a third transceiver pair 306, including a first transceiver 202-3 and a second transceiver 204-3, up to an N-th transceiver pair, that includes a first transceiver 202-N and a second transceiver 204-N.

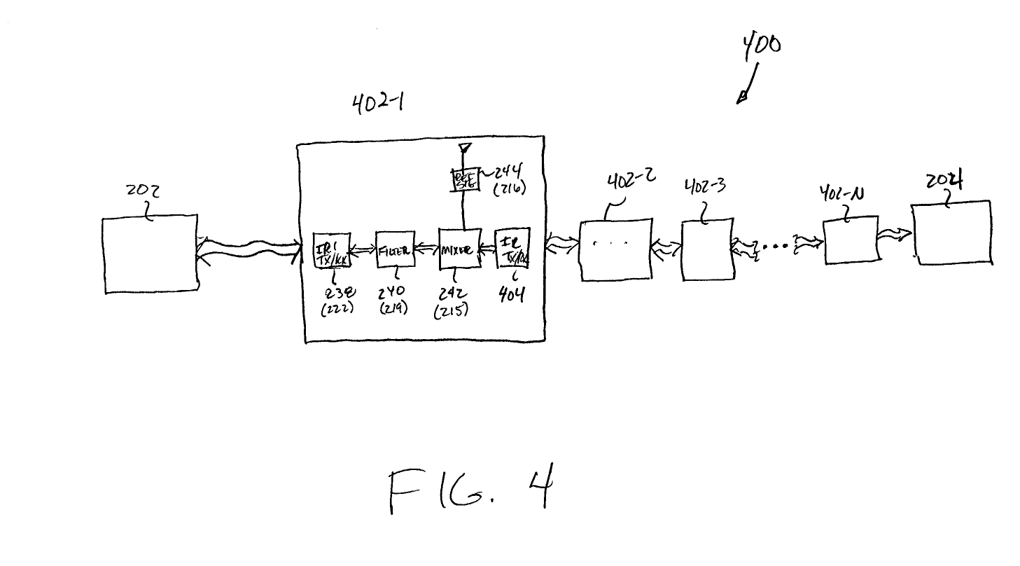

In yet another embodiment depicted in FIG. 4, the system 400 includes one or more third transceivers 402-1, 402-2, 402-3, . . . 402-N that are coupled between the first 202 and second 204 transceivers. The one or more third transceivers 402-1, 402-2, 402-3, . . . 402-N include circuitry substantially identical to those portions of the first 202 and second 204 transceivers that convert modulated IR signals to modulated RF signals. Indeed, those portions that are identical are referenced with like reference numerals to that of FIG. 2 (with the reference numerals that correspond to the first transceiver 202 in parentheses). However, where these one or more third transceivers 402-1, 402-2, 402-3, . . . 402-N differ is that instead of including an RF transceiver 246 (212), each includes an additional IR transceiver 404. Thus, the one or more third transceivers 402-1, 402-2, 402-3, . . . 402-N function as IR repeaters for transmitting modulated IR signals that are substantially identical to the first modulated IR signal output from the first transceiver 202.

The system and method for communicating modulated RF signals described herein provides secure, high-speed, broadband wireless information transmission without incurring significant capital costs for installation or modification, while simultaneously preventing further congestion of the RF spectrum. The transceivers disclosed herein can be readily installed in almost any environment where re-transmission of modulated RF signals is required. This includes, but is by no means limited to, within buildings, between buildings, and automobile and train tunnels.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A system for transmitting information modulated radio frequency (RF) signals between a plurality of communication nodes, comprising:
a first transceiver operable to receive a first modulated RF signal and convert the first modulated RF signal to a first modulated infrared (IR) signal; and
a second transceiver operable to receive the first modulated IR signal from the first transceiver and convert the first modulated IR signal to a second modulated RF signal that is substantially equivalent to the first modulated RF signal.

2. The system of claim 1, wherein the first transceiver comprises:
a first signal source operable to supply a first reference signal; and
a first mixer circuit portion coupled to receive the first modulated RF signal and the first reference signal and operable to convert the first modulated RF signal to a third modulated RF signal having a lower principle frequency than the first modulated RF signal.

3. The system of claim 2, wherein the first signal source comprises:
a first satellite transceiver circuit portion operable to receive and transmit a timing signal from a Global Positioning System (GPS) satellite as the first reference signal.

4. The system of claim 2, wherein the first transceiver further comprises:
an IR transmitter portion coupled to receive the third modulated RF signal and convert the third modulated RF signal to the first modulated IR signal.

5. The system of claim 4, wherein:
the IR transmitter portion comprises a variable intensity IR source; and
the first modulated IR signal is generated by modulating the intensity of the IR source.

6. The system of claim 5, wherein the variable intensity IR source comprises a laser diode.

7. The system of claim 2, wherein the first transceiver further comprises:
a first low-pass filter circuit portion coupled to receive the third modulated RF signal from the first mixer circuit portion and operable to filter unwanted high frequency components therefrom; and
an IR transmitter portion coupled to receive the filtered third modulated RF signal from the low-pass filter circuit portion and convert the third modulated RF signal to the first modulated IR signal.

8. The system of claim 1, wherein the second transceiver comprises:
an IR receiver portion operable to receive the first modulated IR signal from the first transceiver and convert the first modulated IR signal to a fourth modulated RF signal that is substantially equivalent to the third modulated RF signal.

9. The system of claim 8, wherein:
the IR receiver portion comprises an IR sensitive device; and
the fourth modulated RF signal is generated by modulating a voltage magnitude across the diode.

10. The system of claim 8, wherein the second transceiver comprises:
a second signal source operable to supply a second reference signal; and
a second mixer circuit portion coupled to receive the fourth modulated RF signal and the second reference signal and operable to convert the fourth modulated RF signal to the second modulated RF.

11. The system of claim 10, wherein the second signal source comprises:
a second satellite transceiver circuit portion operable to receive and transmit a timing signal from a Global Positioning System (GPS) satellite as the second reference signal.

12. The system of claim 8, wherein the second transceiver further comprises:
a second signal source operable to supply a second reference signal; and
a second low-pass filter circuit portion coupled to receive the fourth modulated RF signal from the IR receiver and filter unwanted high frequency components therefrom; and
a second mixer circuit portion coupled to receive the filtered fourth modulated RF signal and the second reference signal and operable to convert the filtered fourth modulated RF signal to the second modulated RF signal.

13. The system of claim 1, wherein the first transceiver is further operable to receive a second modulated IR signal and convert the second modulated IR signal to a third modulated RF signal.

14. The system of claim 1, wherein the second transceiver is further operable to receive a fourth modulated RF signal and convert the fourth modulated RF signal to a second modulated IR signal.

15. The system of claim 1, wherein:
the second transceiver is further operable to receive a third modulated RF signal and convert the fourth modulated RF signal to a second modulated IR signal; and
the first transceiver is further operable to receive the second modulated IR signal and convert the second modulated IR signal to a fourth modulated RF signal that is substantially equivalent to the third modulated RF signal.

16. The system of claim 15, further comprising:
N-number of first and second transceivers configured in series with one another, whereby the second modulated RF signal output by one of the N-number of second transceivers is received by another one of the N-number of first transceivers, and the third modulated RF signal output by one of the N-number of first transceivers is received by another one of the N-number of second receivers.

17. The system of claim 15, further comprising:
one or more third transceivers placed between the first and second transceivers, each of the third transceivers operable to receive a modulated IR signal and retransmit an other modulated IR signal that is substantially equivalent to the received modulated RF signal.

18. A method of transmitting information modulated radio frequency (RF) signals between a plurality of communication nodes, comprising:
converting, at a first node, a first modulated RF signal to a first modulated infrared (IR) signal;
transmitting the first modulated IR signal from the first node to a second node;
receiving, at the second node, the first modulated IR signal; and
converting the first modulated IR signal to a second modulated RF signal that is substantially equivalent to the first modulated RF signal.

19. The method of claim 18, wherein the step of converting at the first node comprises:
mixing a first reference signal with the first modulated RF signal to convert the first modulated RF signal to a third modulated RF signal having a lower principle frequency than the first modulated RF signal.

20. The method of claim 19, wherein the first reference signal comprises a timing signal transmitted from a GPS.

21. The method of claim 19, wherein the third modulated RF signal is converted to the first modulated IR signal.

22. The method of claim 19, wherein the step of converting at the first node further comprises:
filtering the third modulated RF signal to remove unwanted high-frequency signal components therefrom.

23. The method of claim 18, wherein the step of converting at the second node comprises:
converting the received modulated IR signal to a fourth modulated RF signal; and
mixing a second reference signal with the fourth modulated RF signal to convert the fourth modulated RF signal to the second modulated RF signal.

24. The method of claim 23, further comprising:
filtering the fourth modulated RF signal to remove unwanted high-frequency signal components therefrom, prior to mixing it with the second reference signal.

25. The method of claim 23, wherein the second reference signal comprises a timing signal transmitted from a GPS.

26. The method of claim 18, further comprising:
retransmitting the second modulated RF signal.

27. The method of claim 26, further comprising:
repeating the steps of claim 16 N-number of times.

28. The method of claim 18, further comprising:
receiving, at the first node, a second modulated IR signal from the second node;
converting the second modulated IR signal to a third modulated RF signal; and
transmitting the third modulated RF signal.

29. The method of claim 18, further comprising:
receiving, at the second node, a third modulated RF signal;
converting the third modulated RF signal to a second modulated IR signal; and
transmitting the second modulated IR signal to the first node.

30. The method of claim 18, further comprising:
receiving, at the second node, a third modulated RF signal;
converting the third modulated RF signal to a second modulated IR signal;
transmitting the second modulated IR signal to the first node;
receiving, at the first node, the second modulated IR signal; and
converting the second modulated IR signal to a fourth modulated RF signal that is substantially equivalent to the third modulated RF signal.

31. A system for transmitting information modulated radio frequency (RF) signals between a plurality of communication nodes, comprising:
a first transceiver operable to receive (i) a first modulated RF signal and convert the first modulated RF signal to a first modulated infrared (IR) signal and (ii) a second modulated IR signal and convert the second modulated IR signal to a second modulated RF signal; and
a second transceiver operable to receive (i) the first modulated IR signal from the first transceiver and convert the first modulated IR signal to a third modulated RF signal and (ii) a fourth modulated RF signal and convert the fourth modulated RF signal to the second modulated RF signal,
wherein the second modulated RF signal is substantially equivalent to the fourth modulated RF signal and the third modulate RF signal is substantially equivalent to the first modulated RF signal.

32. A method of transmitting information modulated radio frequency (RF) signals between a plurality of communication nodes, comprising:
converting, at a first node, a first modulated RF signal to a first modulated infrared (IR) signal;
transmitting the first modulated IR signal from the first node to a second node;
receiving, at the second node, the first modulated IR signal;
converting the first modulated IR signal to a second modulated RF signal;
converting, at the second node, a third modulated RF signal to a second modulated IR signal;
transmitting the second modulated IR signal from the second node to the first node;
receiving, at the first node, the second modulated IR signal; and
converting the second modulated IR signal to a fourth modulated RF signal,
wherein the second modulated RF signal is substantially equivalent to the first modulated RF signal and the fourth modulated RF signal is substantially equivalent to the third modulated RF signal.
